(19) United States
(12) Patent Application Publication
(10) Pub. No.: US 2005/0112434 A1
(43) Pub. Date: May 26, 2005

(54) Polymer electrolyte composition for direct methanol fuel cell with suppressed methanol crossover

(75) Inventors: Jung Ki Park, Daejeon (KR); Ki-Yun Cho, Daejeon (KR); Ho-Young Jung, Daejeon (KR)

Correspondence Address: STERNE, KESSLER, GOLDSTEIN & FOX PLLC, 1100 NEW YORK AVENUE, N.W., WASHINGTON, DC, 20005, US

(73) Assignee: Korea Advanced Institute of Science and Technology, Daejeon (KR)

(21) Appl. No.: 10/948,752

(22) Filed: Sep. 24, 2004

(30) Foreign Application Priority Data
Sep. 24, 2003 (KR) 10-2003-0066220

(51) Int. Cl. H01M 8/10; C08J 5/20; H01M 6/18

(52) U.S. Cl. 429/30; 429/33; 429/314; 429/315; 429/316; 429/317; 521/27

(57) ABSTRACT

The present invention is directed to a polymer electrolyte composition for a direct methanol fuel cell which comprises a perfluorinated ionomer (A) and a crosslinked hydrocarbon-based ionomer (B). In some embodiments, the crosslinked hydrocarbon-based ionomer (B) can be obtained by crosslinking a mixture of a monomer containing ionic groups b₁, a crosslinking agent b₂, a monomer for controlling mechanical properties b₃ and an initiator b₄. The polymer electrolyte composition can minimize methanol crossover, exhibit improved proton conductivity and exhibit excellent mechanical properties.

This application claims priority to Korean Patent Application No. 10-2003-0066220, filed Sep. 24, 2003, which is incorporated by reference herein in its entirety.

### BACKGROUND OF THE INVENTION

1. Field of the Invention

The present invention is directed to a polymer electrolyte composition for a direct methanol fuel cell which comprises a perfluorinated ionomer and a crosslinked hydrocarbon-based ionomer. More particularly, the present invention is directed to a polymer electrolyte composition for a direct methanol fuel cell with excellent proton-conducting and mechanical properties while exhibiting suppressed methanol crossover.

2. Related Art

Fuel cells are direct current generators which directly convert the chemical energy of a fuel to electrical energy. Unlike other generators, fuel cells are not limited by the Carnot cycle and thus exhibit high energy efficiency and produce less exhaust gases. Fuel cells enable continuous electricity generation so long as fuel is continuously supplied to the fuel cells, whereas primary and secondary batteries are charged and supply only limited energy.

Depending on operating temperature and electrolyte type, fuel cells are divided into the following categories: proton exchange membrane fuel cells (PEMFCs), alkali fuel cells (AFCs), phosphoric acid fuel cells (PAFCs), molten carbonate fuel cells (MCFCs), and solid oxide fuel cells (SOFCs).

PEMFCs are fuel cells which utilize a proton-conducting polymer membrane as an electrolyte. Direct methanol fuel cells (DMFCs) which use methanol as fuel in place of hydrogen are classified separately from PEMFCs. PEMFCs and DMFCs utilizing polymer membranes as electrolytes have low operating temperatures, short start-up times, and fast response characteristics to load changes when compared to other fuel cells. In particular, since these fuel cells use a polymer membrane as an electrolyte, there is no corrosion, no need for pH adjustment, and weak sensitivity of reaction gases to pressure change. In addition, compared to phosphoric acid fuel cells having the same operational temperature, PEMFCs and DMFCs are advantageous due to their simple design, ease of manufacturing, and small volume and weight. In addition to these advantages, PEMFCs and DMFCs generate a wide range of outputs, and thus can be applied to many fields, e.g., power sources for clean vehicles, homes, spacecrafts, military devices and portable devices, etc. Since DMFCs can be operated at ambient pressure and room temperature, they can replace conventional secondary batteries used as portable power sources for small devices such as cellular phones, laptop, camcorders, etc.

However, the most significant limitation to the commercialization of DMFCs is methanol crossover. Methanol crossover is a phenomenon wherein methanol passes from anode to cathode through the polymer electrolyte membrane, thus deteriorating performance of the fuel cell. Due to methanol crossover in DMFCs, the potential difference between the cathode and the anode is small, a great deal of fuel is wasted, and the reduction reaction in the cathode is interfered, thereby decreasing the current density. Accordingly, there is a need to develop a membrane with minimized methanol crossover.

A number of efforts have been made to minimize the occurrence of methanol crossover in DMFCs, e.g., by blending a polymer containing no ionic groups with a perfluorinated ionomer or mixing the polymer with an inorganic salt. Although these efforts are effective in decreasing methanol crossover, they also reduce ionic conductivity and cause deterioration of some mechanical properties.

### SUMMARY OF THE INVENTION

The present invention provides a polymer electrolyte composition for a direct methanol fuel cell which minimizes methanol crossover, exhibits excellent mechanical properties, and exhibits improved proton conductivity at small thicknesses.

The present invention provides a polymer electrolyte composition for a direct methanol fuel cell, comprising a perfluorinated ionomer (A) and a crosslinked hydrocarbon-based ionomer (B).

### BRIEF DESCRIPTION OF THE DRAWINGS/FIGURES

FIG. 1 is a schematic diagram showing the structure of a polymer electrolyte membrane for a direct methanol fuel cell comprising a perfluorinated ionomer 1 and a crosslinked hydrocarbon-based ionomer 2. The crosslinked hydrocarbon-based ionomer 2 is distributed in a crosslinked state through the internal pores and/or surface layers of the perfluorinated ionomer 1.

FIG. 2 is a graph showing change in proton conductivity of a polymer electrolyte composition for a direct methanol fuel cell.

FIG. 3 is a graph showing change in methanol permeability of a polymer electrolyte composition for a direct methanol fuel cell.

FIG. 4 is a graph showing cell performance of polymer electrolyte membranes fabricated from a polymer electrolyte composition for a direct methanol fuel cell. Semi-Interpenerating networks (Semi-IPNs) represent the electrolyte membranes.

### DETAILED DESCRIPTION OF THE INVENTION

The present invention is directed to a polymer electrolyte composition for a direct methanol fuel cell, comprising a perfluorinated ionomer (A) and a crosslinked hydrocarbon-based ionomer (B).

The term “perfluorinated ionomer” as used herein refers to an ionomer wherein C—H bonds are replaced with C—F bonds in the backbone, while possessing ion exchangeability.

In some embodiments, the perfluorinated ionomer (A) in the composition of the present invention can be, but is not limited to, 0.01% to 99.99% by weight, or 60% to 95% by weight, of the composition of the present invention. When the content of the perfluorinated ionomer (A) is less than 0.01% by weight, there is a risk of low ionic conductivity. When the content of the perfluorinated ionomer (A) exceeds 99.99% by weight, the ionic conductivity is improved but methanol crossover is not suppressed. In some embodiments, the perfluorinated ionomer (A) can be a perfluorosulfonic acid ionomer, such as the ionomer sold under the tradenames Nafion® (DuPont), Aciplex® (Asahi Chemical), Flemion® (Asahi Glass), or combinations of these ionomers.

In some embodiments, the crosslinked hydrocarbon-based ionomer (B) is an ionomer obtained by crosslinking a mixture of a monomer containing ionic groups b₁, a crosslinking agent b₂, a monomer for controlling mechanical properties b₃, and an initiator b₄. In some embodiments, a polymer electrolyte composition for a direct methanol fuel cell can be provided by impregnating a perfluorinated ionomer (A) in a solution of a monomer containing ionic groups b₁, a crosslinking agent b₂, a monomer b₃ for controlling mechanical properties, and an initiator b₄.

In some embodiments, the content of the crosslinked hydrocarbon-based ionomer (B) can be, but is not limited to, 0.01% to 99.99% by weight or 0.01% to 50% by weight of the composition of the present invention. When the content of the crosslinked hydrocarbon-based ionomer (B) is less than 0.01% by weight, methanol crossover through a membrane is not significantly improved. On the other hand, when the content of the crosslinked hydrocarbon-based ionomer (B) exceeds 99.99% by weight, mechanical strength is poor and ionic conductivity is low.

The monomer b₁ can be any vinyl monomer with one or more suitable ionic groups. In some embodiments, the content of the monomer b₁ containing the ionic group can be, but is not limited to, 0.1% to 80% by weight of the crosslinked hydrocarbon-based ionomer (B). When the ionic group is a sulfonic group, the monomer b₁ can, but is not limited to, acrylamidomethylpropanesulfonic acid, styrenesulfonic acid, methacryloxyethanesulfonic acid, methylpropanesulfonic acid, hydroxypropanesulfonic acid or combinations thereof. When the ionic group is a carboxyl group, the monomer b₁ can be, but is not limited to, methylmethacrylic acid, ethylacrylic acid, acrylic acid, derivatives thereof, or combinations thereof.

The monomer b₂ can be any crosslinking agent with diacrylate or dimethyl acrylate. In some embodiments, the crosslinking agent b₂ can be, but is not limited to, hexanediolethoxylate diacrylate, hexanediolpropoxylate diacrylate, dimethylacrylate, polyethyleneglycol dimethacrylate, polyethyleneglycol diacrylate, trimethylolpropane, trimethacrylate, or combinations thereof. In some embodiments, the content of the crosslinking agent b₂ in the crosslinked hydrocarbon-based ionomer (B) can be, but is not limited to, 0.1% to 50% by weight of the crosslinked hydrocarbon-based ionomer (B).

In some embodiments, the monomer b₃ is added to control the physical properties of a final product and can be, but is not limited to, vinyl-based monomers, acrylate-based monomers, methacrylate-based monomers, or combinations thereof. In some embodiments, the monomer b₃ can be, but is not limited to, ethylhexylacrylate, ethylhexylmethacrylate, ethylmethacrylate, n-butylacrylamide, vinylacetate or α-olefin-based monomers. The monomer b₃ is related with physical properties controlled by the length of the side chain at b₃.

In some embodiments, the initiator b₄ can be, but is not limited to, photopolymerization initiators and thermal polymerization initiators. The photopolymerization initiators can be, but are not limited to, benzophenone, benzoin or 1-chloroanthracene. The thermal polymerization initiators can be, but are not limited to, benzoylperoxide or 2,2′-azobisisobutyronitrile.

Any solvent that sufficiently dissolves the monomer containing ionic group b₁, the crosslinking agent b₂, and the monomer b₃ for controlling mechanical properties, and facilitates the crosslinking reaction by the initiator b₄, can be used as the organic solvent. Suitable organic solvents include, but are not limited to, dimethylformamide (DMF), N-methylpyrrolidone (NMP), N,N′-dimethylacetamide (DMAc), dichlorobenzene (DCB), dimethylsulfoxide (DMSO), tetrahydrofuran (THF) and the like.

In some embodiments, the crosslinking reaction is performed by photocrosslinking. In some embodiments, the photocrosslinking is UV crosslinking, e.g., wherein the UV crosslinking is performed at room temperature and a humidity of 20% or less.

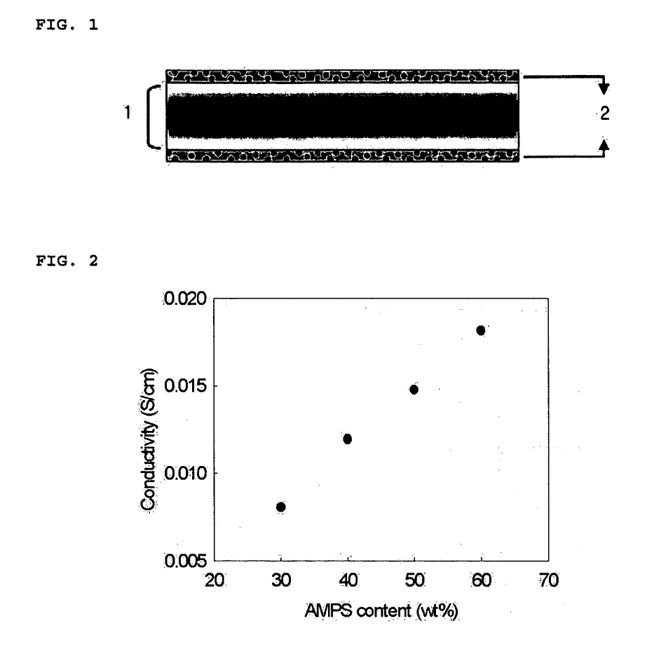

An exemplary polymer electrolyte membrane fabricated according to the present invention is shown in FIG. 1.

It will be readily apparent to one of ordinary skill in the relevant arts that other suitable modifications and adaptations to the compositions and applications described herein are obvious and can be made without departing from the scope of the invention or any embodiment thereof. Having now described the present invention in detail, the same will be more clearly understood by reference to the following examples, which are included herewith for purposes of illustration only and are not intended to be limiting of the invention.

### EXAMPLE 1

A Nafion® 112 membrane (DuPont) was pretreated in H₂O₂ for 2 hours, in 1M H₂SO₄ for 2 hours, and in H₂O for 2 hours to remove impurities present on the membrane surface. The pretreatment was carried out at 80° C. The pretreated membrane was impregnated in a solution containing 0.6 g of 2-acrylamido-2-methyl-1-propanesulfonic acid (AMPS), 0.2 g of 1,6-hexanediol ethoxylate diacrylate (HEDA), and 0.4 g of 2-ethylhexyl acrylate (EHA) dissolved in 40 mL of dimethylformamide (DMF), and then 0.002 g of benzophenone as a photopolymerization initiator was added thereto. 2-Ethylhexyl acrylate (EHA) was then added to improve flexibility. The mixture was subjected to a photocrosslinking reaction at room temperature for 10 minutes to fabricate a membrane. The resistance of the membrane was measured using an FRA (Frequency Response Analyzer) and the proton conductivity was calculated from the measured values. The results are shown in FIG. 2. Further, the methanol permeability of the membrane was measured, and the obtained results are shown in FIG. 3. The experimental results demonstrate that methanol crossover was suppressed while the proton conductivity was maintained at a level similar to that of the commercially available Nafion® membrane.

### EXAMPLE 2

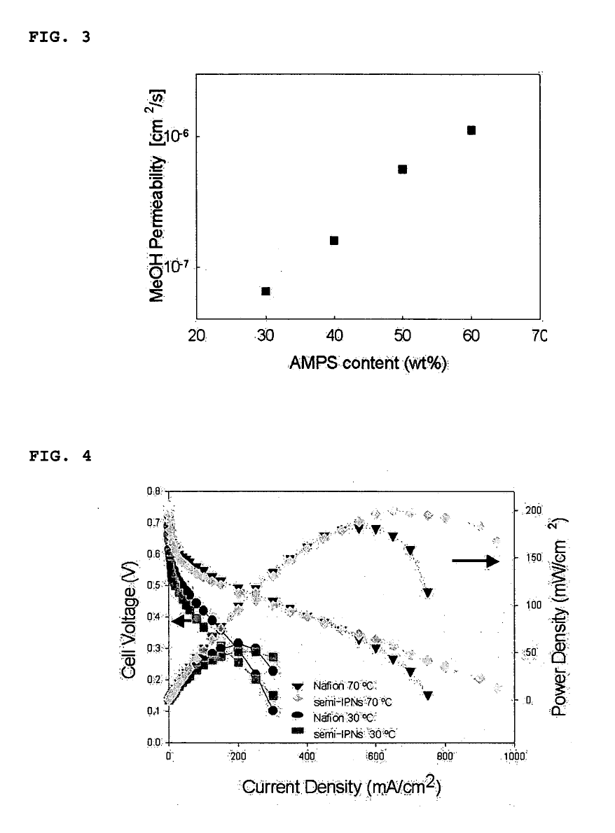

Polymer electrolyte membranes were fabricated as described in Example 1, except that commercially available Nafion® 115 and Nafion® 117 polymer membranes having different thicknesses were used instead of the Nafion® 112 membrane. The cell performance of the polymer electrolyte membranes was measured, and the results are shown in FIG. 4. FIG. 4 confirmed that the maximum power density values of the electrolyte membranes were 200 mW/cm², whereas those of the commercially available Nafion® membranes were 180 mW/cm². Thus, the cell performance of the electrolyte membranes was improved by 11%, compared to the commercially available membranes.

### EXAMPLE 3

Polymer electrolyte membranes were fabricated as described in Example 1, except that Flemion® (Asahi Glass) and Aciplex® (Asahi Chemical) were used as the perfluorinated ionomers. The proton conductivity was similar to that of Example 1.

### EXAMPLE 4

A polymer electrolyte membrane was fabricated as described in Example 1, except that 0.01% by weight of benzoyl peroxide was used as a thermal polymerization initiator instead of benzophenone as a photopolymerization initiator. The maximum power density was 182 mW/cm².

### EXAMPLE 5

A polymer electrolyte membrane was fabricated as described in Example 1, except that styrenesulfonic acid was added instead of 2-acrylamido-2-methyl-1-propanesulfonic acid (AMPS) containing a sulfonic acid group. The proton conductivity of this sample was decreased, however the methanol crossover was enhanced.

As apparent from the above description, the present invention provides a polymer electrolyte composition for a direct methanol fuel cell which can minimize methanol crossover, and can exhibit excellent mechanical properties and improved proton conductivity even at a small thickness.

These examples illustrate possible methods of the present invention. While the invention has been particularly shown and described with reference to some embodiments thereof, it will be understood by those skilled in the art that they have been presented by way of example only, and not limitation, and various changes in form and details can be made therein without departing from the spirit and scope of the invention. Thus, the breadth and scope of the present invention should not be limited by any of the above-described exemplary embodiments, but should be defined only in accordance with the following claims and their equivalents.

All documents cited herein, including journal articles or abstracts, published or corresponding U.S. or foreign patent applications, issued or foreign patents, or any other documents, are each entirely incorporated by reference herein, including all data, tables, figures, and text presented in the cited documents.

1. A polymer electrolyte composition for a direct methanol fuel cell, comprising a perfluorinated ionomer (A) and a crosslinked hydrocarbon-based ionomer (B).

2. The polymer electrolyte composition of claim 1, wherein the crosslinked hydrocarbon-based ionomer (B) comprises:
(a) a monomer containing ionic groups b₁;
(b) a crosslinking agent b₂;
(c) monomer for controlling mechanical properties b₃; and
(d) an initiator b₄.

3. The polymer electrolyte composition of claim 1, wherein the crosslinked hydrocarbon-based ionomer (B) is obtained by crosslinking:
(a) a monomer containing ionic groups b₁;
(b) a crosslinking agent b₂;
(c) a monomer for controlling mechanical properties b₃; and
(d) an initiator b₄.

4. The polymer electrolyte composition of claim 1, wherein the crosslinked hydrocarbon-based ionomer (B) is present in an amount of 0.01% to 99.99% by weight of the composition.

5. The polymer electrolyte composition of claim 3, wherein the crosslinked hydrocarbon-based ionomer (B) is present in an amount of 0.01% to 99.99% by weight of the composition.

6. The polymer electrolyte composition of claim 3, wherein the monomer-containing ionic group b₁ is a sulfonic or carboxyl group.

7. The polymer electrolyte composition of claim 3, wherein the monomer-containing ionic b₁ is present in an amount of 0.1% to 80% by weight of the crosslinked hydrocarbon-based ionomer (B).

8. The polymer electrolyte composition of claim 6, wherein the monomer-containing ionic b₁ is present in an amount of 0.1% to 80% by weight of the crosslinked hydrocarbon-based ionomer (B).

9. The polymer electrolyte composition of claim 3, wherein the monomer-containing ionic group b₁ is selected from the group consisting of acrylamidomethylpropanesulfonic acid, styrenesulfonic acid, methacryloxyethanesulfonic acid, methylpropanesulfonic acid, hydroxypropanesulfonic acid, and combinations thereof.

10. The polymer electrolyte composition of claim 6, wherein the monomer-containing ionic group b₁ is selected from the group consisting of acrylamidomethylpropanesulfonic acid, styrenesulfonic acid, methacryloxyethanesulfonic acid, methylpropanesulfonic acid, hydroxypropanesulfonic acid, and combinations thereof.

11. The polymer electrolyte composition of claim 3, wherein the monomer-containing ionic group b₁ is selected from the group consisting of methylmethacrylic acid, ethylacrylic acid, acrylic acid, derivatives thereof, and combinations thereof.

12. The polymer electrolyte composition of claim 6, wherein the monomer-containing ionic group b₁ is selected from the group consisting of methylmethacrylic acid, ethylacrylic acid, acrylic acid, derivatives thereof, and combinations thereof.

13. The polymer electrolyte composition of claim 3, wherein the crosslinking agent b₂ is selected from the group consisting of hexanediolethoxylate diacrylate, hexanediolpropoxylate diacrylate, dimethylacrylate, polyethyleneglycol dimethacrylate, polyethyleneglycol diacrylate, trimethylolpropane, trimethacrylate, and combinations thereof.

14. The polymer electrolyte composition of claim 13, wherein the crosslinking agent b₂ is present in an amount of 0.1% to 50% by weight of the crosslinked hydrocarbon-based ionomer (B).

15. The polymer electrolyte composition of claim 3, wherein the monomer for controlling mechanical properties b₃ is selected from the group consisting of vinyl-based monomers, acrylate-based monomers methacrylate-based monomers, and combinations thereof.

16. The polymer electrolyte composition of claim 3, wherein the monomer b₃ is selected from the group consisting of ethylhexylacrylate, ethylhexylmethacrylate, ethylmethacrylate, n-butylacrylamide, vinylacetate α-olefin-based monomers, and combinations thereof.

17. The polymer electrolyte composition of claim 15, wherein the monomer b₃ is selected from the group consisting of ethylhexylacrylate, ethylhexylmethacrylate, ethylmethacrylate, n-butylacrylamide, vinylacetate α-olefin-based monomers, and combinations thereof.

18. The polymer electrolyte composition of claim 3, wherein the initiator b₄ is a photopolymerization initiator or a thermal polymerization initiator.

19. The polymer electrolyte composition of claim 3, wherein the initiator is a photo-initiator selected from the group consisting of benzophenone, benzoin, 1-chloroanthracene, and combinations thereof.

20. The polymer electrolyte composition of claim 18, wherein the initiator is a photo-initiator selected from the group consisting of benzophenone, benzoin, 1-chloroanthracene, and combinations thereof.

21. The polymer electrolyte composition of claim 3, wherein the initiator is a thermal-initiator selected from the group consisting of benzoylperoxide, 2,2′-azobisisobutyronitrile, and combinations thereof.

22. The polymer electrolyte composition of claim 18, wherein the initiator is a thermal-initiator selected from the group consisting of benzoylperoxide, 2,2′-azobisisobutyronitrile, and combinations thereof.

23. he polymer electrolyte composition of claim 1, wherein the perfluorinated ionomer (A) is present in an amount of 0.01% to 99.99% by weight of the composition.

24. The polymer electrolyte composition of claim 1, wherein the perfluorinated ionomer (A) is a perfluorosulfonic acid ionomer.

25. The polymer electrolyte composition of claim 3, wherein the perfluorinated ionomer (A) is a perfluorosulfonic acid ionomer.

26. The polymer electrolyte composition of claim 23, wherein the perfluorinated ionomer (A) is a perfluorosulfonic acid ionomer.

27. A method of making the polymer electrolyte composition of claim 1, the method comprising:
(a) impregnating a membrane with
(i) a monomer containing an ionic groups b₁,
(ii) a crosslinking agent b₂;
(iii) a monomer for controlling mechanical properties b₃; and
(iv) an initiator b₄; and
(b) photocrosslinking the impregnated membrane of (a).

28. The composition made by the method of claim 27.

29. The fuel cell comprising the polymer electrolyte composition of claim 1.
